(19) United States
(12) Patent Application Publication
(10) Pub. No.: US 2025/0042035 A1
(43) Pub. Date: Feb. 6, 2025

(54) METHOD FOR AUTOMATIC IDENTIFICATION AND CONTROL OF A ROBOT CRAWLING UNDER A ROLL CART

(71) Applicant: VIETTEL GROUP, Ha Noi City (VN)

(72) Inventors: Dinh Hoan Trinh, Ha Noi City (VN); Quoc Cuong Ninh, Ha Noi City (VN); The Nam Le, Ha Noi City (VN)

(73) Assignee: VIETTEL GROUP, Ha Noi City (VN)

(21) Appl. No.: 18/432,586

(22) Filed: Feb. 5, 2024

(30) Foreign Application Priority Data
Jul. 31, 2023 (VN) 1-2023-05131

(51) Int. Cl. B25J 9/16; B25J 5/00

(52) U.S. Cl. CPC B25J 9/1697; B25J 5/007; B25J 9/1692

(57) ABSTRACT

The invention proposes a method and system for automatically identifying and controlling a robot to enter the undercarriage of roll carts. Specifically, the method and system proposed in the invention belong to the field of autonomous mobile robots (AMRs) applied in the transportation of goods in warehouses. The invention relates to the field of robot vision and automatic control.

### BACKGROUND

Until recently, the traditional AGV (Automated Guided Vehicles) line of automatically guided robots was the only option for automating intralogistics transportation tasks. AGVs require a tightly controlled, fixed, and procedural operating environment in which the cargo transportation task must be consistent and repetitive, and thus the initial cost is high. However, today, AGVs are being challenged by the AMR (Autonomous Mobile Robot) line, which is equipped with more sophisticated technology, operates more flexibly and efficiently. AMRs are equipped with sensors such as lidar, cameras, computers, etc., with the ability to connect to the Internet of Things (IoTs), and are installed with intelligent algorithms that help AMRs become increasingly efficient, perform many difficult tasks and do not require a pre-designed and expensive operating environment like the AGV line. Therefore, AMRs are becoming increasingly popular and gradually replacing the AGV line in the performance of cargo transportation tasks in warehouses.

In industrial warehouses, goods are usually stored in standard RC (Roll carts). AMR robots receive instructions to transport RC with pickup and drop-off points set by the control center. The transportation process will be carried out in the following steps. First, the robot will move to the position in front of the cart to be transported. Then, the robot needs to perform the task of crawling into the cart's undercarriage accurately. Next, the robot lifts the cart off the ground and moves it to the desired location. It can be seen that the task of automatically crawling into the narrow undercarriage of the RC is an indispensable task of the AMR robot line.

In this document, we disclose a solution to automatically identify and crawl into the undercarriage of an RC for the AMR robot line. The type of RC used is a rectangular cargo with four wheels at four corners. The AMR robot mentioned is a robot with a differential steering mechanism using two side drive wheels and self-driving wheels in the front and rear. There are many solutions to the problem of AMR robots automatically crawling into the undercarriage of RC vehicles. In general, the solutions all perform signal analysis from the robot's sensors to determine the position of the RC vehicle, and then control the two drive wheels to automatically move the robot into the cargo undercarriage.

In practice, AMR robots can use 2D or 3D Lidar sensors to detect the position of the cargo cart. Lidar is a sensor device that uses lasers to measure distances and reconstruct a 2D (with 2D Lidar) or 3D (with 3D Lidar) space around it. With 2D Lidar, the signal containing information about the RC is only a few strips of reflected points of the cart in its cross-section, making it very difficult to identify the cart undercarriage, especially in cases where the carts are relatively free or they are placed close together. Therefore, with 2D Lidar, the position and initial direction of the robot in front of the cargo cart must be relatively optimized. Sometimes it is required that special shaped objects are added to each RC so that Lidar receives good reflection light of those shapes to determine the position of the cargo cart in space. 3D Lidar is usually quite expensive, which increases the cost of the robot, making it difficult to maintain and replace.

Other solutions use a feedback control mechanism with a PID controller to move into the RC undercarriage by equipping with proximity sensors. When the robot moves, these sensors will warn of a collision between the robot and the two side wheels of the cart, the robot will adjust its direction so that it is equidistant from these two wheels. Unlike Lidar, proximity sensors are relatively inexpensive but have low accuracy, and often require the RC to be placed in a specified position.

Another solution is to equip the autonomous robot with a camera and use directional labels such as Aruco Tag or April Tag stickers on the RC. Through the camera, the robot will be able to detect these labels in the surrounding environment and calculate the direction and position of the cargo cart relative to the robot, then control the robot to the desired position. This is an effective, low-cost solution because 2D cameras are inexpensive. However, to implement this, it is necessary to install directional codes on all RC and be consistent in position. This manual installation will be difficult for large warehouses with a significant number of cargo carts. Especially with logistics warehouses, RC are also transported all over the place, making it difficult to gather and install these codes simultaneously. Moreover, in a working environment with dirt and mold, these codes will lose accuracy compared to the original.

The proposed solution herein also uses a cheap 2D camera, but does not require the use of special boards attached to the RC as in conventional camera solutions, while still ensuring accuracy, stability, and the ability to customize with many environments thanks to the use of artificial intelligence image analysis technology.

### SUMMARY

The purpose of the invention is to propose a method and system to perform the task of automatically identifying and controlling a robot to crawl into the undercarriage of an RC for the AMR autonomous robot line in warehouses using only a conventional 2D camera and without any changes to or additional information on the RC. The technical solution in this invention takes advantage of the power of artificial intelligence technology in real-time image analysis to be able to recognize and identify the position and direction of the cargo cartfrom camera image information. In addition, the ability to create a moving trajectory to the target and follow that trajectory.

In the proposed technical solution, we build an artificial intelligence model to be able to automatically detect and identify the appearance of the RC in the image of the 2D camera equipped on the robot, and simultaneously determine the coordinates of the pixel of some important positions of the goods cart on the frame in real time. The camera is modeled as a mathematical model to simulate the process of creating a 2D image from its 3D real space. From this mathematical model, the camera parameters representing the correlation between the real 3D space and the 2D image of the camera will be determined. Next, an inverse calculation algorithm is presented to estimate the relative position in the real 3D space between the robot and the RC based on the pixel coordinates of some important points on the cargo cart that have been previously determined. Based on this relative position information (position and direction of the robot relative to the RC undercarriage), the robot will automatically control the movement to reach the desired position, which is to lie directly under the RC. The entire process is fully processed by the robot's computer.

Key features of the invention:
Uses a conventional 2D camera: This makes the solution more cost-effective and easier to implement.
Requires no special labels or tags on the RC vehicles: This makes the solution more flexible and adaptable to different environments.
Uses artificial intelligence for real-time image analysis: This allows the robot to accurately identify and position itself relative to the RC vehicle, even in cluttered environments.

Accordingly, the automatic identification and control system for the robot to crawl into the undercarriage of a cargo cartmentioned in the invention includes the following component Modules:

Communication Module: connects the camera and the computer in the robot compartment, controls the reception of the image data stream from the camera.

Intelligent Perception Module: receives the image stream from the camera containing information about the environment in front of the robot. The Intelligent Perception Module contains an AI model that has been trained to be able to detect and identify the cargo cart as well as obstacles if any in the camera's field of view.

Trajectory Planning Module serves as the planner hub, translating spatial information between the robot, camera, and cargo cart coordinate systems. Leveraging data extracted from the Intelligent Perception Module, it calculates a transformation matrix representing the relative pose (position and orientation) of the cargo cart with respect to the camera. This information is then fused with knowledge of the camera-robot relationship, ultimately yielding a comprehensive understanding of the cargo cart's location and direction relative to the robot. Equipped with this spatial awareness, the Module generates an optimal trajectory for the robot's movement, meticulously planning a collision-free path from its current position to the target undercarriage destination within the cargo vehicle. This process prioritizes efficiency while ensuring safe and precise robot navigation within the complex environment.

Navigation Module serves as the robot's onboard pilot, translating the calculated trajectory from the Trajectory Planning Module into actionable commands for the motion system. It continuously receives and integrates data from various sensor sources, including obstacle detection systems, to ensure adherence to the planned path while maintaining situational awareness. In the event of unexpected obstacles, the Module dynamically adjusts the trajectory or triggers evasive maneuvers, prioritizing both operational efficiency and safety. This real-time feedback loop between planning and execution enables the robot to navigate the complex environment with precision and adaptability.

In addition, the automatic identification and control method for the robot to crawl into the cargo cart undercarriage includes the following steps:
Step 1: Camera calibration and intelligent perception algorithm construction:

Camera calibration is a process of determining the parameters of the camera, such as the focal length, lens distortion, and pixel size. This information is used to accurately convert the coordinates of points in the image plane to real coordinates in space. A deep learning model is initialized and trained to obtain the optimal weights from the collected data.
Step 2: Read the image from the camera in the communication module

Transmit the image packet from the camera device to the robot's central processing unit through the ROS (robot operating system).
Step 3: Deep learning-driven cargo cart information extraction

Leveraging deep learning, these models analyze input images to detect the presence of cargo carts. Upon confirmation, they accurately pinpoint the coordinates of key cart features within the image plane.
Step 4: Distance and Direction Estimation from Feature Correspondences

By establishing mathematical correspondences between image plane points and their real-world coordinates, a system of equations is formulated. Solving this system yields the rotation and translation matrix representing the cargo cart's pose relative to the robot. This crucial step unlocks the robot's spatial awareness, paving the way for precise movement and successful undercarriage navigation.
Step 5: Create a movement trajectory from the robot to the cargo cart position:

From the relative position of the cargo cart and the robot in space, create a trajectory that includes a set of points that the robot needs to pass through to crawl under the cargo vehicle.
Step 6: Apply the control algorithm to move the robot along the established trajectory:

Control the robot to follow the set trajectory, stop when encountering obstacles on the road, and end when the robot reaches the cargo undercarriage position.

With the proposed technical solution, the type of cargo cart to be identified can be specified in advance by the user, for example, the user can select cargo forms from the available dataset. With a new cargo type, only the recognition image and cargo design parameters need to be provided. In the case that a part of the cargo cart is obscured, based on the design information, the robot can interpolate the missing parts to continue the calculation and movement process. Therefore, this technical solution has very high flexibility and is easy to use in practice.

### BRIEF DESCRIPTION OF DRAWINGS

FIG. 1: camera and roll cart coordinates systems;

FIG. 2: describes the Modules and steps to implement the technical solution;

FIG. 3: describes the process of training data and implementation of deep learning models;

### DETAILED DESCRIPTION OF THE EMBODIMENTS

The detailed description of the invention below is based on the accompanying drawings, which are intended to illustrate the embodiments of the invention without limiting the scope of protection of the invention.

The invention is directed to the automatic control of a robot moving into the undercarriage of a cargo cart using a 2D camera. Although not limited to any specific robot, a suitable robot that the invention can be applied to is a robot that serves in the logistics process.

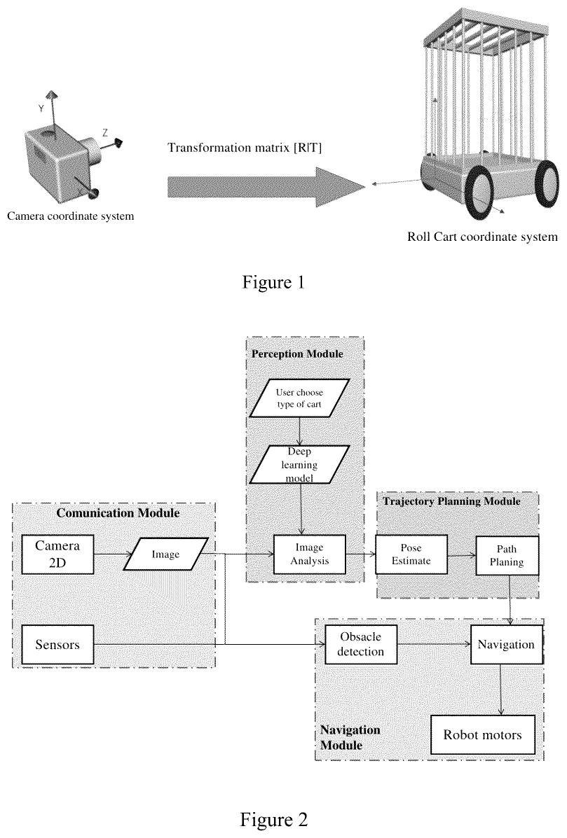

Specifically, the automatic identification and control system for a robot crawling under a cargo cart mentioned in the invention includes 04 component Modules as illustrated in FIG. 2, as follows:

Communication Module: reads data recorded from the camera device, packages the data into complete packets and sends it to the processor through the robot operating system (ROS). After receiving these packets, the processor will proceed to decode to obtain the image value.

Intelligent Perception Module: receives the image stream from the communication Module (via the camera) containing information about the environment in front of the robot. The intelligent perception Module contains an AI model that has been trained to be able to detect and identify cargo vehicles as well as obstacles if they appear in the camera's field of view.

Trajectory Planning Module serves as the planner hub, translating spatial information between the robot, camera, and cargo cart coordinate systems. Leveraging data extracted from the Intelligent Perception Module, it calculates a transformation matrix representing the relative pose (position and orientation) of the cargo cart with respect to the camera. This information is then fused with knowledge of the camera-robot relationship, ultimately yielding a comprehensive understanding of the cargo cart's location and direction relative to the robot. Equipped with this spatial awareness, the Module generates an optimal trajectory for the robot's movement, meticulously planning a collision-free path from its current position to the target undercarriage destination within the cargo vehicle. This process prioritizes efficiency while ensuring safe and precise robot navigation within the complex environment.

Navigation Module serves as the robot's onboard pilot, translating the calculated trajectory from the Trajectory Planning Module into actionable commands for the motion system. It continuously receives and integrates data from various sensor sources, including obstacle detection systems, to ensure adherence to the planned path while maintaining situational awareness. In the event of unexpected obstacles, the Module dynamically adjusts the trajectory or triggers evasive maneuvers, prioritizing both operational efficiency and safety. This real-time feedback loop between planning and execution enables the robot to navigate the complex environment with precision and adaptability.

### Method for Automatic Identification and Control of a Robot Crawling Under a Roll Cart is Performed According to the Following Steps:

Step 1: Camera calibration and intelligent perception algorithm construction

Within the context of warehouse logistics robots employing this invention, the expansive field of view offered by a fisheye camera holds immense potential for environmental data acquisition. However, the resulting curvilinear image format necessitates rectification prior to high-level analysis. This initial step addresses this challenge through a Fisheye Camera Calibration. A mathematical model, the “fisheye camera model” accurately simulates the image formation process, accounting for inherent lens parameters and distortion characteristics. Through a meticulously executed calibration procedure utilizing a dedicated checkerboard pattern, crucial camera parameters like focal length, optical center, and distortion coefficients are precisely estimated. Leveraging these extracted parameters, the original image undergoes a rigorous rectification process, effectively transforming the curved image into a planar representation, free from hardware-induced distortions and imaging artifacts.

Before installing the robot in the working environment, it is necessary to know information about the type of cargo cart such as shape, technical design parameters of the RC cargo vehicle, a dataset of 2D images of cargo vehicles, and pre-determine some feature points on the cargo cart such as the corner of the cargo vehicle, the intersection points of the frame bars. An artificial intelligence model is trained on a sample image dataset to be able to perform the tasks of detecting and identifying cargo vehicles and some characteristic points about cargo vehicles in the image. The deep learning model training process is illustrated in FIG. 2. After training, the model with the optimal weight set will be saved to perform automatic information extraction in the next step.
Step 2: Read the image from the camera in the communication module

The image read from the cameras mounted on the robot will be in the form of a 3D array corresponding to the three color channels red, green, and blue (R, G, B). The image will be packaged into packets that include the value of the array that has been encoded into bytes, the size of the array, the encoding type, and the timestamp of the image (time-stamp). The packet is sent to the central processor of the robot using the TCP (Transmission Control Protocol) protocol in the form of topics defined by the robot operating system (ROS). After receiving these packets, the processor will proceed to decode to obtain the value of the image, perform preprocessing, normalize the color channels, and change the fixed size to be compatible with the deep learning model.
Step 3: Deep learning-driven cargo cart information extraction

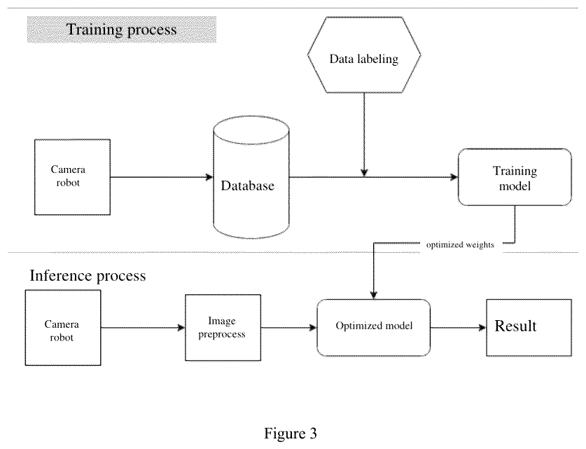

This crucial step leverages optimized deep learning models to extract pertinent cargo cart information from the pre-processed image within the intelligent perception Module. As depicted in FIG. 3, successful execution relies on a normalized and resized input image.

Cargo Cart Detection: The initial analysis employs a specialized “cargo cart detection model” such as a trained Yolo v5 convolutional regression model, to detect the presence and location of cargo carts within the image frame. This efficiently filters out irrelevant background objects and distant carts, streamlining subsequent processing.

Cargo Segmentation and Feature Identification: Upon successful cargo identification, the image embarks on a two-fold deep learning analysis. First, a segmentation model, typically comprised of encoder and decoder branches, meticulously classifies each pixel within the image, accurately delineating the boundaries of the identified cargo cart.

Secondly, a feature detection model pinpoints the locations of pre-defined key points on the cargo cart (e.g., corners, frame intersections). This model ensures at least four distinct features are identified, allowing for interpolation of missing features based on known cargo design parameters in case of occlusions. The segmented regions and detected features are then combined to definitively associate features with the specific cargo cart.

Feature Output and Subsequent Processing: This comprehensive analysis culminates in a set of identified features and their corresponding positions within the image. This vital information serves as the foundation for the next step, where the robot's relative position and orientation to the target cargo cart are calculated using these extracted features.
Step 4: Distance and direction estimation from feature correspondences

In this step, from the positions of the cargo cart features on the 2D image that were identified in step 3, the rotation matrix and translation from the robot coordinate system to the cargo cart coordinate system need to be estimated. To do this, first place the camera coordinate system and the cargo cart coordinate system as shown in FIG. 1. Next, for each feature point, determine the relationship between its coordinates on the image plane (in Step 3) and in the 3D cargo cart coordinate system according to the following equation:

$$s [ \begin{matrix}u \\ v \\ 1\end{matrix} ] = A [ \begin{matrix}{X}_{C} \\ {Y}_{C} \\ {Z}_{C}\end{matrix} ] = A [ R \vert t ] [ \begin{matrix}{X}_{W} \\ {Y}_{W} \\ {Z}_{W} \\ 1\end{matrix} ] ,$$

where s is the projective transformation's arbitrary scaling, [u, v, 1] is the coordinate of a feature point on the image plane, [X_{c}, Y_{c}, X_{c}] and [X_{w}, Y_{w}, X_{w}] respectively are the corresponding coordinates of the feature point in the camera coordinate system and the RC coordinate system, A is a camera intrinsic matrix that was found in step 1, and [R|t] is a 3×4 matrix including the rotation and translation that describe the change from the RC coordinate system to the camera view coordinate system.

With each feature point, one conversion equation will be established as above, with n feature points we have n binding equations for calculating the matrix [R|t]. Through the perspective n-point algorithm, the matrix [R|t] is estimated. The matrix [R|t] represents the relationship between the camera coordinate system and the cargo cart coordinate system in six degrees of freedom, including three rotation angles roll, pitch, yaw and translation along three axes x, y, z.

On the other hand, the translation matrix between the robot coordinate system and the camera coordinate system mounted on it is known, it is easy to calculate the distance and orientation between the robot and the cargo cart.

This step yields the transformational parameters between the robot and cargo vehicle coordinate systems, encoding both translation and rotation.
Step 5: Create a movement trajectory from the robot to the cargo cart position in the Trajectory Planning Module

After step 4, we have the translation matrix from the robot coordinate system to the cargo cart coordinate system in 3D space. From this matrix, project onto the horizontal plane parallel to the ground, considering the center of the cargo cart as the origin of the two-dimensional coordinate system Oxy, then we represent the current position of the robot as a vector (x₀; y₀). Next, set up the waypoints on the trajectory that the robot will pass through. There are many ways to set up, this invention provides an example with 5 waypoints as follows:

$$P 1 ( {x}_{0} , {y}_{0} ) ; P 2 ( {x}_{0} * \frac{5}{6} , {y}_{0} * \frac{1}{2} ) ; P 3 ( {x}_{0} * \frac{2}{3} , 0 ) ; P 4 ( {x}_{0} * \frac{1}{3} , 0 ) ; P 5 ( 0 , 0 ) .$$

Use the Cubic-Spline interpolation with the input as the list of waypoints designed above to generate a trajectory that is a set of points (Cₓ, C_{y}, θ) spaced a very small distance apart representing the position and direction at the points that the robot needs to pass through from the current position, through the waypoints, to the center of the cargo vehicle.
Step 6: Apply the control algorithm to move the robot along the generated trajectory in the navigation Module

After the trajectory is determined, it is necessary to set up a feedback control loop for the motor to move the robot along that trajectory. The robot used here is a differential wheeled robot (differential wheeled robot) that moves based on two separate drive wheels placed on the sides of the robot body along with freely rotating steering wheels placed in front and back. By changing the moment applied to the motor of each drive wheel, the relative speed of the wheels is changed, causing the robot to change direction without the need for additional steering movement.

At each time the robot moves, we identify the nearest point on the generated trajectory and the robot's instantaneous position, and then calculate the difference between the two positions. Set up a feedback loop with feedback input is the position error as above along with the error with the set velocity, then determine the control law that satisfies the Lyapunov condition as the output for the controller. When the robot reaches the target point, the target point will be changed to the next nearest point to the robot on the trajectory. This process will be repeated until the robot follows the entire trajectory and moves to the center of the cargo vehicle.

During the movement, the controller will continuously update information from the sensors equipped on the robot to determine if there are obstacles within the robot's movement range. Some sensors that can be mentioned, but are not limited to the patent, such as 2D cameras, ultrasound. If the obstacle is in the unsafe area when the robot moves, the robot will stop and issue a warning by sound or signal sent out. Until there are no more obstacles, the robot will continue to move along the set trajectory.

Although the descriptions above contain many specific details, they are not considered to be limitations on the implementation method of the invention, but only for the purpose of illustrating some preferred implementation methods.

1. A method and system for automatically identifying and controlling a robot to crawl under a cargo vehicle, including the following components: a Communication Module that bridges a connection between a camera and a computer, receiving an image stream; an Intelligent Perception Module that analyzes the image stream, employing an AI model to detect the cargo vehicle, extract feature points in a surface of the cargo vehicle; a Trajectory Planning Module that translates information between coordinate systems and uses extracted data to determine a pose of the cargo vehicle relative to the robot and camera, then generating a planned trajectory that comprises an optimal collision-free path to reach the cargo vehicle, prioritizing efficiency and safety; a Navigation Module that translates the planned trajectory into motor commands and continuously monitors an environment of the robot through sensors, wherein if obstacles arise, the Navigation Module dynamically adjusts the path or triggers evasive maneuvers, ensuring the robot safely and efficiently reaches its destination, wherein the method comprises the following steps:
Step 1: Calibrate the camera and build an intelligent perception algorithm in the communication module;
An artificial intelligence model is trained on a sample image dataset to perform the tasks of real-time localizing cargo vehicles and their characteristic points in the image stream from camera, The camera parameters is also offline calibrated, The AI model with an optimal weight set and camera parameters are saved and used for the next steps;
Step 2: Read the image from the camera in the communication module
Video stream is decoded to obtain the digital image, and then perform image preprocessing procedures including normalization of color channels, and image resize to be compatible with the deep learning model;
Step 3: Deep learning-based cargo cart information extraction
Extracting useful cargo cart information from the pre-processed image within the intelligent perception module;
Cargo Cart Detection: employ a “cargo cart detection model” to detect the presence and location of cargo carts within the image frame, filtering out irrelevant background objects and distant carts, for streamlining subsequent processing;
Cargo Segmentation and Feature Identification: Upon cargo vehicle identification, the perform a two-fold deep learning analysis; employ a segmentation model, comprised of encoder and decoder branches, to classify each pixel within the image, delineating the boundaries of the identified cargo cart;
employ a feature detection model to pinpoint locations of pre-defined key points on the cargo cart, ensuring that at least four distinct features are identified, allowing for interpolation of missing features based on known cargo design parameters in case of occlusions, combining segmented regions and detected to associate features with the specific cargo cart;
Step 4: Use the associated features to determine a distance and direction of the cargo cart to the robot in space in the Trajectory Planning Module
using the positions of the cargo cart features on the 2D image that were identified in step 3, estimate a rotation matrix and translation from the robot coordinate system to the cargo cart coordinate system, position the camera coordinate system and the cargo cart coordinate system, for each feature point, determine a relationship between its coordinates on the image plane in Step 3 and in the 3D cargo cart coordinate system according to the following equation:
$$s [ \begin{matrix}u \\ v \\ 1\end{matrix} ] = A [ \begin{matrix}{X}_{C} \\ {Y}_{C} \\ {Z}_{C}\end{matrix} ] = A [ R \vert t ] [ \begin{matrix}{X}_{W} \\ {Y}_{W} \\ {Z}_{W} \\ 1\end{matrix} ] ,$$
where s is a projective transformation's arbitrary scaling, [u, v, 1] is a coordinate of a feature point on the image plane, [X_{c}, Y_{c}, X_{c}] and [X_{w}, Y_{w}, X_{w}] are corresponding coordinates of the feature point in the camera coordinate system and the RC coordinate system, respectively, A is a camera intrinsic matrix that was found in step 1, and [R|t] is a 3×4 matrix including rotation and translation that describe the change of coordinates from the RC coordinate system to the camera coordinate system;
With each feature point, establish one conversion equation as above, with n feature points providing n binding equations for estimating the matrix [R|t], where [R|t] represents the relationship between the camera coordinate system and the cargo cart coordinate system in six degrees of freedom, including three rotation angles roll, pitch, yaw and translation along three axes x, y, z;
Calculate the distance and orientation between the robot and the cargo cart, to obtain the transformational parameters between the robot and cargo vehicle coordinate systems, encoding both translation and rotation;
Step 5: Create a movement trajectory from the robot to the cargo cart position in the Trajectory Planning Module
from the translation matrix from the robot coordinate system to the cargo cart coordinate system in 3D space, project onto a horizontal plane parallel to the ground, considering the center of the cargo cart as the origin of the two-dimensional coordinate system Oxy, representing a current position of the robot as a vector (x₀;y₀), next, set up waypoints on a trajectory that the robot will pass through with 5 waypoints as follows:
$$P 1 ( {x}_{0} , {y}_{0} ) ; P 2 ( {x}_{0} * \frac{5}{6} , {y}_{0} * \frac{1}{2} ) ; P 3 ( {x}_{0} * \frac{2}{3} , 0 ) ; P 4 ( {x}_{0} * \frac{1}{3} , 0 ) ; P 5 ( 0 , 0 ) ;$$
P5(0, 0) using Cubic-Spline interpolation with the input as the list of waypoints designed above to generate a trajectory that is a set of points (Cₓ, C_{y}, θ) spaced a distance apart representing the position and direction at the points that the robot needs to pass through from the current position, through the waypoints, to the center of the cargo vehicle;
Step 6: Apply a control algorithm to move the robot along the generated trajectory in the navigation Module.

2. The method and system for automatically identifying and controlling a robot to crawl under a cargo cart according to claim 1, in which the method and process of calculating the relative position of the robot and the cargo cart through a 2D camera allows the user to select the type of cargo cart to be detected.

3. The method and system for automatically identifying and controlling a robot to crawl under a cargo cart according to claim 1, in which the user can add a new type of cargo cart by providing images and cargo cart design information.

4. The method and system for automatically identifying and controlling a robot to crawl under a cargo cart according to claim 1, in which the method implements a solution to combine multiple deep learning models to provide information on whether there is a cargo cart in the observation area or which features belong to the same cargo vehicle.

5. The method and system for automatically identifying and controlling a robot to crawl under a cargo cart according to claim 3, in which the calculation method allows for interpolation of missing or undetected features due to occlusion.

6. The method and system for automatically identifying and controlling a robot to crawl under a cargo cart according to claim 1, in which if an obstacle is detected on the path to the cargo vehicle, the robot will issue a warning and stop until the obstacle is no longer on the path.

7. The method and system for automatically identifying and controlling a robot to crawl under a cargo cart according to claim 1, in which a nonlinear controller is follows a discretized trajectory, the robot only considers the reference point is the point on the trajectory closest to it in space.

8. The method and system for automatically identifying and controlling a robot to crawl under a cargo cart according to claim 1, wherein the initial analysis employs a specialized “cargo cart detection model” trained on a Yolo v5 convolutional regression model.

9. The method and system for automatically identifying and controlling a robot to crawl under a cargo cart according to claim 1, wherein the pre-defined key points on the cargo cart comprise corners or frame intersections.

10. The method and system for automatically identifying and controlling a robot to crawl under a cargo cart according to claim 1, wherein the matrix [R|t] is estimated through a perspective n-point algorithm.
